(19) United States
(12) Patent Application Publication
(10) Pub. No.: US 2011/0039513 A1
(43) Pub. Date: Feb. 17, 2011

(54) MOBILE COMMUNICATIONS TERMINAL AND METHOD FOR ALARM NOTIFICATION

(75) Inventor: Bengt Carlstrom, Danderyd (SE)

Correspondence Address: MOORE & VAN ALLEN PLLC, P.O. BOX 13706, Research Triangle Park, NC, 27709, US

(73) Assignee: Skygd AB, Stockholm (SE)

(21) Appl. No.: 12/745,480

(22) PCT Filed: Nov. 17, 2008
(86) PCT No.: PCT/SE2008/051321

§ 371 Date: Nov. 1, 2010

(30) Foreign Application Priority Data
Nov. 30, 2007 (SE) 0702653.7

(51) Int. Cl. H04M 11/04; H04W 24/00

(52) U.S. Cl. 455/404.1; 455/456.1

(57) ABSTRACT

A mobile communications terminal configured to handle bi-directional voice calls is provided that includes a microphone means, a sound buffer, a loudspeaker means, a positioning means and a processing means. The microphone means is configured to register sound data to be sent out and the loudspeaker means is configured to generate acoustic signals based on incoming sound data. The positioning means is configured to calculate position data reflecting an estimated geographic position of the terminal based on received satellite signals. The processing means is configured to handle surveillance commands and user-generated commands and, in response thereto, control the microphone means to register sound data and cause repeated storage of the sound data in the sound buffer and originate an alarm message, which is adapted to provide at least one predefined recipient with access to the stored sound data and position data generated by the terminal.

### THE BACKGROUND OF THE INVENTION AND PRIOR ART

The present invention relates generally to solutions for generating and sending alarm notifications to desired recipients. More particularly the invention relates to a mobile communications terminal according to the preamble of claim 1 and a method according to the preamble of claim 11. The invention also relates to a computer program product according to claim 20 and a computer readable medium according to claim 21.

The introduction of positioning functions in low-cost consumer products, such as mobile telephone terminals has enabled new services and applications. For example, various map and navigation applications are thus rendered possible. However, besides assisting the mobile user directly, the position data may also be used to notify others, for instance in connection with an emergency situation. Thereby, in case of an accident, or if the user is subjected to an assault, relevant persons, service functions and/or authorities can efficiently be informed of the user's location. As a result, the chances of aiding the user adequately are improved. Of course, another effect of carrying an alarm device of this type is that the user generally becomes less worried to visit environments in which he/she otherwise would have experienced discomfort, or anxiety, due to the risk of being attacked.

EP 1 575 010 describes a detector and people-monitoring device for the provision of tele-assistance. The device, which may be integrated into a watch or a bracelet, repeatedly registers its position. In case of emergency, a user of the device controls the device to activate a communications system, e.g. via a mobile telephone. When activating the alarm, the device sends its position coordinates to the mobile telephone together with a reason for raising the alarm. One example of such a reason is that the wearer of the device is located outside a pre-defined geographic area. The device may include an audio connection, so that a voice connection can be established via its associated the telephone.

US 2007/0182548 discloses an apparatus for providing information regarding a missing person (e.g. a child) to a monitoring station, a so called a remote emergency control center (ECC). The apparatus is included in a watch, which is secured to a subject. The apparatus, in turn, includes a GPS receiver, a photo/video recorder and an audio microphone. Upon activation of an alarm, the ECC is informed of the location of the apparatus and its user. At this point in time, the photo/video recorder is also started automatically, such that the ECC can be provided with live image data from the apparatus location (e.g. 30 still photos every 2 seconds or a 60 seconds video stream). Preferably, after activating the alarm, the subject may talk, and listen, to personnel at the ECC. Moreover, such conversations may be stored in a database of the ECC.

US 2005/0083195 reveals a personal security system, which is disguised as a conventional mobile communications device (MCD), e.g. in the form of a cellular phone. The MCD includes a GPS receiver and a wireless communications means. The MCD has two modes of operation—an audible mode and a silent mode. The former is used to fend off a perpetrator by emitting a loud noise, whereas in the latter mode an emergency monitoring service (EMS) is contacted secretly. When activated, the MCD contacts an EMS and transmits its position coordinates. The EMS returns an acknowledgement signal, and in response thereto the MCD activates a microphone to monitor the user's environment, and dispatches the corresponding assistance or authorities.

D2 U.S. Pat. No. 6,711,399 discloses a device and method for emergency calling of an assistance center. Here, a vehicle is provided with an on-board system including a location module for estimating the position of the vehicle. A sensor in the vehicle also estimates the number of passengers in the vehicle. Thus, in case of an accident, the assistance center can be provided with vital information for any aiding service personnel.

Although the above-mentioned solutions may indeed assist a person in case of emergency, all the known systems are problematic because in order to transmit acoustic data from the alarm site, they require a live audio connection between the user's terminal and at least one outside party. However, in many actual critical situations the events evolve so quickly that when the alarm is activated much of the interesting acoustic information is already history. Moreover, after having activated the alarm it may not be possible for a user to maintain a phone connection, and especially not to communicate directly with the outside party. For example, when the user realizes that the alarm should be activated he/she may already be fettered, injured and/or gagged and therefore unable to speak. Furthermore, the assailants may be so aggressive/violent that establishing and maintaining a phone connection is impossible, or at least highly inappropriate.

U.S. Pat. No. 6,278,884 describes a conventional portable cellular phone, which has been modified to include various security alarm functions. However, no discrete confirmation of that a transmitted alarm message has been adequately received can be generated. Hence, the person in jeopardy will remain unnecessarily anxious, and he/she may issue repeated alarm messages, which in turn, risk downloading the system.

### SUMMARY OF THE INVENTION

The object of the present invention is to alleviate the above problems and provide an improved alarm notification means with respect to usability, efficiency, reliability, and most important, discrete confirmation that an alarm message has been adequately received.

According to the invention, the object is achieved by the terminal as initially described, wherein the terminal is adapted to receive an acknowledge message from the server resource. The acknowledge message is generated in response to the supplementary information. The processing means, in turn, is configured to produce a user-perceivable confirmation indication in response to the acknowledge message. The terminal also includes a vibrator means via which the confirmation indication may be generated discretely.

This terminal design is advantageous, since it provides the alarm message recipient with highly relevant data in a very convenient and straightforward manner. Namely, the buffered sound data may contain information which, in case of an emergency situation, cannot be created once such a situation arises. The at least one alarm recipient is further given a basis to take adequate actions to assist the person who requested the alarm. Moreover, the user of the terminal becomes aware of that the server resource has received the user-generated command (i.e. the alarm request) without risking that any assaulting person notifies this.

According to one preferred embodiment of the invention, the terminal is configured to receive the surveillance command in the form of a user-generated input to the terminal, e.g. by depressing a particular button, key or switch (or combination thereof) or by uttering a certain voice command.

According to another preferred embodiment of the invention, the positioning means is configured to associate a time stamp with each calculated position date. The time stamp reflects a point in time when the terminal was estimated to be located at the geographic position associated thereto. Furthermore, the processing means is configured to produce the alarm message, such that the at least one recipient thereof is provided with access to a latest calculated position date and its associated time stamp. Thereby, based on the time stamp and the current time, the recipient may conclude whether the user of the originating terminal is likely to still be located at the indicated position, or if he/she may have moved since then (typically into an environment where satellite signals are occluded).

According to a further preferred embodiment of the invention, the alarm message is represented by short messages service (SMS) message and/or an electronic mail message. In both cases, relatively rich information may be transferred quickly and reliably to multiple recipients.

According to another preferred embodiment of the invention, the alarm message comprises a uniform resource locator (URL) to a World Wide Web (WWW) resource, e.g. represented by a web page, and a passphrase adapted to provide access to said World Wide Web resource. Thus, exclusively authorized recipients may view and act on the message. Naturally, this is beneficial from a security point-of-view.

According to yet another preferred embodiment of the invention, the processing means is configured to automatically set up a call to a predefined party in response to the user-generated command. Typically (however not necessarily), this party is identical to one of the at least one recipients of the alarm message. Consequently, the thus connected party is able to receive live sounds that are recorded by the terminal's microphone means. Preferably, the connection is bi-directional, such that if deemed appropriate, the called party may talk to the user of the terminal, for example in order to guide the user to a safe location.

According to a further preferred embodiment of the invention, the processing means is configured to, after having set up the call, automatically adjust the microphone means to a sensitivity above a first threshold value (e.g. to a maximal value), and/or adjust the loudspeaker means to a volume level above a second threshold value. Hence, a desired terminal behavior is conveniently attained, and the user friendliness is enhanced.

According to another preferred embodiment of the invention, the terminal includes an image recording means and a storage means configured to store image data generated by the image recording means. Moreover, in response the user-generated command, the processing means is configured to forward a subset of the image data stored in the storage means to the server resource. Hence, one or more recipients may be provided with a latest set of static images registered by the terminal, and/or a latest recorded video sequence. Depending on the user's assessment of the situation and his/her actions prior to initiating the alarm, this data may contain very valuable information concerning the alarm situation.

According to another aspect of the invention, the object is achieved by the method described initially, wherein the method further comprises generating an acknowledge message in the server resource in response to the supplementary information, sending the acknowledge message to the terminal. Thereafter, the proposed method involves producing a confirmation indication in the terminal in response to the acknowledge message. The confirmation indication involves activating a vibrator means in the terminal. The advantages of this method, as well as the preferred embodiments thereof, are apparent from the discussion above with reference to the proposed receiver.

According to a further aspect of the invention the object is achieved by a computer program product, which is directly loadable into the memory of a computer, and includes software adapted to implement the method proposed above when said program is run on a computer.

According to another aspect of the invention the object is achieved by a computer readable medium, having a program recorded thereon, where the program is adapted to control a computer to perform the method proposed above when the program is loaded into the computer.

Further advantages, beneficial features and applications of the present invention will be apparent from the following description and the dependent claims.

### BRIEF DESCRIPTION OF THE DRAWINGS

The present invention is now to be explained more closely by means of preferred embodiments, which are disclosed as examples, and with reference to the attached drawings.

FIG. 1 shows a block diagram of a mobile communications terminal according to one embodiment of the invention;

FIG. 2 shows a schematic system which is configured to communicate with the proposed terminal; and

FIG. 3 illustrates, by means of a flow diagram, a general method of operating a mobile communications terminal according to the invention.

### DESCRIPTION OF PREFERRED EMBODIMENTS OF THE INVENTION

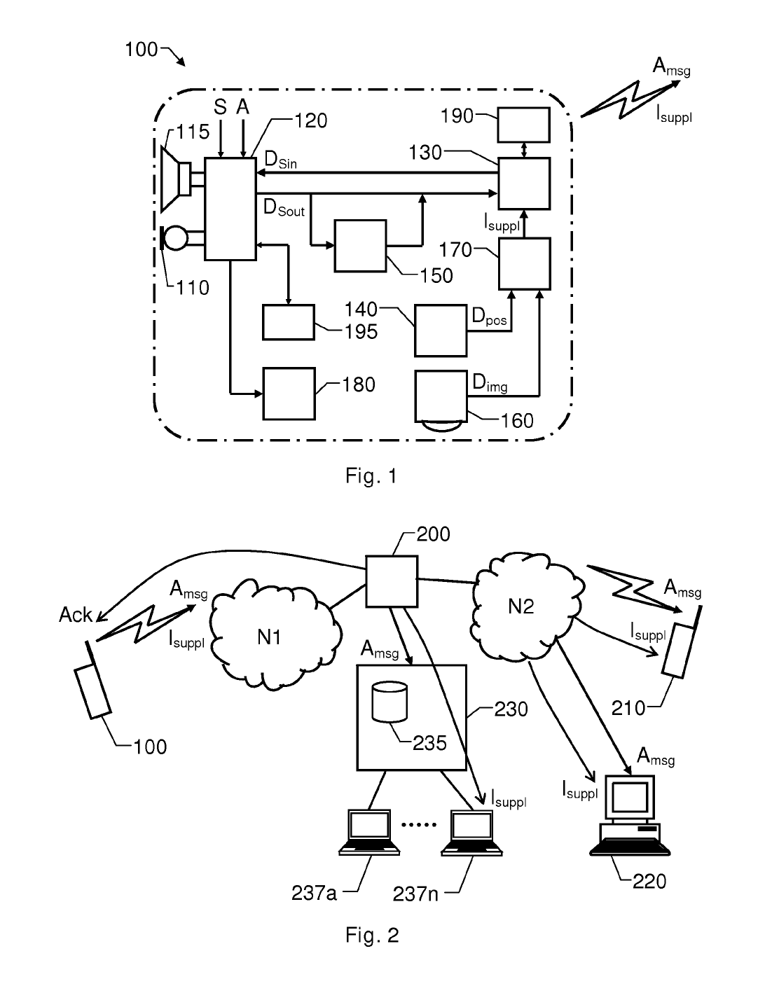

FIG. 1 shows a block diagram of a mobile communications terminal 100 according to one embodiment of the invention. The terminal 100 is configured to handle bi-directional voice calls in a wireless communication network. This feature will be discussed further below with reference to FIG. 2. The terminal 100 includes a microphone means 110; a sound buffer 150, a loudspeaker means 115, a positioning means 140, a processing means 120 and a radio front end 190. The terminal 100 preferably also includes a data control module 130, an imaging means 160, a storage means 170, a vibrator means 180, and/or a memory module 195.

The microphone means 110 is configured to register sound data D_{Sout} to be transmitted over a wireless communication network, for instance via the processing means 120, the data control module 130 and the radio front end 190. However, according to the invention, the sound data D_{Sout} may also be stored sequentially in the sound buffer 150. The conditions for effecting this storage will be discussed below.

The loudspeaker means 115 is configured to generate acoustic signals based on incoming sound data D_{Sin}. Typically, these data D_{Sin} are received in the terminal 100 the from wireless communication network via the radio front end 190, and then forwarded to the loudspeaker means 115 via the data control module 130 and the processing means 120.

The positioning means 140 is configured to calculate position data Dₚₒₛ based on received satellite signals. The position data Dₚₒₛ thus reflect an estimated geographic position of the terminal 100. The positioning means 140 updates the position data Dₚₒₛ repeatedly, for example at regular intervals, say once per second, once per minute, or once every 15 minutes. Preferably, the updating frequency can be selected, either manually by the user, or automatically/adaptively by the terminal 100 depending on various parameters, e.g. the speed at which the terminal 100 moves, its battery capacity or the signal strength of the satellite signals.

Technically, triangulation measurements based on a set of mobile communication system signals can be employed to derive a terminal position. However, for accuracy reasons GNSS-based positioning is generally preferable. There exist many examples of Global Navigation Satellite Systems (GNSS). Presently, the Global Positioning System (GPS; U.S. Government) is the dominant system; however alternative systems are expected to gain increased importance in the future. So far, the Global Orbiting Navigation Satellite System (GLONASS; Russian Federation Ministry of Defense) and the Galileo system (the European programme for global navigation services) constitute the major alternative GNSSs. Various systems also exist for enhancing the coverage, the availability and/or the quality of at least one GNSS in a specific region. The Quasi-Zenith Satellite System (QZSS; Advanced Space Business Corporation in Japan), the Wide Area Augmentation System (WAAS; The U.S. Federal Aviation Administration and the Department of Transportation) and the European Geostationary Navigation Overlay Service (EGNOS; a joint project of the European Space Agency, the European Commission and Eurocontrol—the European Organisation for the Safety of Air Navigation) represent examples of such augmentation systems for GPS, and in the latter case GPS and GLONASS.

According to the invention, the processing means 120 is configured to receive a surveillance command S, which may be generated by the user depressing one or more keys on a keypad of the terminal 100, or uttering a predefined voice command. In response to the surveillance command S, the processing means 120 is configured to control the microphone means 110 to register sound data D_{Sout}, and cause repeated storage of the sound data D_{Sout} in the sound buffer 150. The sound data D_{Sout} are stored sequentially in the sound buffer 150, such that an oldest piece of stored data therein is overwritten with a newest piece of registered data, and so on. Hence, the sound buffer 150 holds a representation of a most recently registered sound sequence at all times (i.e. also during an initial phase before the buffer has been filled).

After having received the surveillance command S, the processing means 120 is also configured to investigate whether or not a user-generated command A has been received. Analogous to the surveillance command S, the command A may be generated by manipulating one or more switches, buttons or keys of the terminal 100. In response to the command A, the processing means 120 is configured to originate an alarm message A_{msg}. This message, in turn, is adapted to provide at least one predefined recipient with access to the sound data D_{Sout} stored in the sound buffer 150 and the position data Dₚₒₛ generated by the terminal 100. The predefined recipients may be referred to as ICE (In Case of Emergency) persons, which can be identified as such in an electronic phonebook of the terminal 100.

According to one preferred embodiment of the invention, the positioning means 140 is configured to associate a time stamp with each calculated position date Dₚₒₛ. The time stamp here reflects a point in time when the terminal 100 was estimated to be located at a given geographic position. The processing means 120 is further configured to produce the alarm message A_{msg} such that each recipient thereof is provided with access to a latest calculated position date Dₚₒₛ as well as the time stamp associated thereto. Thus, on the further basis of the current time, the recipient can deduce how likely it is that the user of the terminal 100 remains essentially at the indicated geographic position, or if he/she may have moved there from.

We now refer to FIG. 2, which schematically shows the proposed terminal 100 and a system configured to communicate with the terminal 100.

We assume that the terminal 100 presently roams within a first wireless communication network N1, and that the terminal 100 is connected to this network N1. A server resource 200 is likewise connected to the first wireless communication network N1, either directly or indirectly via one or more intermediate networks. The server resource 200, in turn, is further connectable to at least one party to represent the recipient(s) of the alarm message A_{msg}. For example, a service central 230 may be connected to the server resource 200. The service central 230 is associated with a number of terminals 237a, . . . , 237n, which each is configured to handle the alarm message A_{msg}. As an alternative or complement to the service central 230, the server resource 200 may be connected to one or more terminals 210 and 220, which are operated by individuals (e.g. friends or relatives to the user of the terminal 100). Each of the terminals 210 and 220 is also configured to handle the alarm message A_{msg}. For instance, a mobile telephone 210 may constitute a first message receiving terminal and a personal computer (PC) may constitute a second message receiving terminal. The mobile telephone 210 may be roaming in the first wireless communication network N1, or as in the illustrated example be connected via a second wireless communication network N2 to which the server resource 200 likewise is connected, directly or indirectly.

The mobile telephone 210 may receive the alarm message A_{msg} in the form of an SMS or an MMS (multimedia service) message, whereas the PC may receive the alarm message A_{msg} in the form of an e-mail. Preferably, in addition to responding to the alarm, the handling of the alarm message A_{msg} in the terminals 237a, . . . , 237n, 210 and 220 involves communicating bi-directionally with the terminal 100 over the first network N1.

According to one preferred embodiment of the invention, the service central 230 is associated with a database 235 containing relevant personal data concerning the user of the terminal 100, such as name, age, gender, information about any health conditions and contact information to relatives. Hence, in connection with receiving the alarm message A_{msg}, an operator of one of the terminals 237a, . . . , 237n may gain access to at least part of the user's personal data in the database 235. The extent of data access may here depend on a predefined user profile.

Returning now briefly to FIG. 1, according to one preferred embodiment of the invention, the processing means 120 is configured to forward supplementary information Iₛᵤₚₚₗ in response to the user-generated command A. The supplementary information Iₛᵤₚₚₗ is retrieved from the storage means 170, and includes the above-mentioned position data Dₚₒₛ and the stored sound data

D_{Sout}. The terminal 100 is configured to forward the supplementary information Iₛᵤₚₚₗ to the server resource 200 via the wireless communication network N1. The server resource 200, in turn, is configured to provide each of the at least one recipient 210, 220 and/or 230 of the alarm message A_{msg} with access to the supplementary information Iₛᵤₚₚₗ.

As mentioned above, the terminal 100 may include an imaging means 160, which is adapted to register static images and/or video sequences in response to user-generated control commands. Additionally, the terminal 100 may include a storage means 170 adapted to store any image data D_{img} registered by the imaging means 160. According to one preferred embodiment of the invention, in response the user-generated command A, the processing means 120 is configured to forward a subset of the image data D_{img} stored in the storage means 170 to the server resource 200, for instance as part of the supplementary information Iₛᵤₚₚₗ. Thereby, the recipient(s) 210, 220 and/or 230 may view one or more images and/or video sequences, say a predefined number of the latest stored files in the storage means 170.

This enables the user to take photographs of (and/or film) suspect/hostile individuals knowing that this information will be sent out along with a future alarm message A_{msg} in case an emergency situation arises. The images and/or video sequences may be recorded before as well as after entering the surveillance command S.

According to one preferred embodiment of the invention, the server resource 200 is configured to return an acknowledge message Ack to the terminal 100 response to the supplementary information Iₛᵤₚₚₗ, and the processing means 120 is configured to produce a user-comprehensible confirmation indication in response to the acknowledge message Ack. For example, the confirmation indication may involve activating the vibrator means 180. Thus, the user can verify that the supplementary information Iₛᵤₚₚₗ has been received by the server resource 200, and hence he/she indirectly knows that the alarm message A_{msg} is being processed by the system.

According to one preferred embodiment of the invention, the alarm message A_{msg} includes a URL (uniform resource locator) to a World Wide Web (WWW) resource and a passphrase adapted to provide access to the WWW resource. Thus, if the receiving terminal is a computer 220, the WWW resource can be accessed by activating a hyperlink in the alarm message A_{msg}. If instead, the receiving terminal is a mobile terminal 210, the WWW resource may be accessed by manually entering the URL and the passphrase into a computer, or by activating a hyperlink in the alarm message A_{msg} (if the terminal 210 itself has WWW-capability). In any case, this feature provides a both convenient and secure access means to the supplementary information Iₛᵤₚₚₗ.

According to one preferred embodiment of the invention, the processing means 120 is configured to automatically set up a call to a predefined party, say the mobile terminal 210, in response to the user-generated command A. Such a call is set up essentially in parallel with the transmission of the alarm message A_{msg}. Depending on how quickly the alarm message A_{msg} passes through the first and second networks N1 and N2, the call may be set up before or after the alarm message A_{msg} reaches its recipients. In any case, it is preferable that the predefined party is identical to one of the at least one recipients of the alarm message A_{msg}. As mentioned initially, the user of the terminal 100 may not be capable of conducting a conventional phone call after having activated the alarm. However, the connection to the predefined party at least enables this party to listen to sounds from the alarm site, and to take further action based thereon.

Additionally, after having set up the call, the processing means 120 may be configured to automatically adjust the microphone means 110 to a sensitivity above a first threshold value, (say to a maximum level); and/or adjust the loudspeaker means 115 to a volume level above a second threshold value (typically a relatively high level). A high microphone sensitivity is generally desirable, since any relevant sound sources (represented by perpetrators and/or victims) may be located relatively remote from the terminal 100. It is more delicate to determine what constitutes an appropriate loudspeaker volume. Depending on the situation, either an extremely low volume, or a comparatively high volume may be optimal. For example, if an attacker still is near the user, a low volume is typically advantageous; whereas if the user is fettered and perhaps has been separated some distance from the terminal, a high volume is most useful. Nevertheless, the user may predefine a default loudspeaker volume to use in this situation.

As mentioned earlier, the terminal 100 preferably includes a memory module 195. This module contains software adapted to control the terminal 100 to operate according to the above-described procedure. This means that, in practice, the terminal 100 may be represented by a conventional mobile telephone, which has been modified by storing specific software therein.

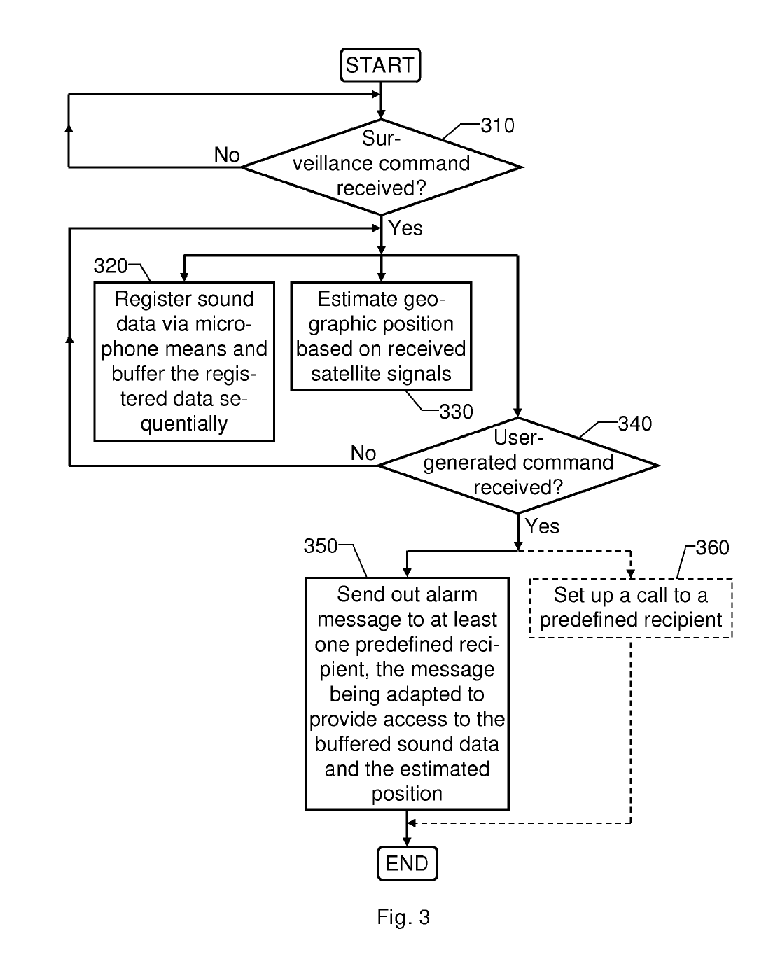

To sum up, we will now describe the general method of controlling a mobile communications terminal according to the invention with reference to the flow diagram in FIG. 3.

An initial step 310 investigates whether or not a surveillance command has been received. If so, a step 320 follows; and otherwise, the procedure loops back and stays in step 310. Step 320 controls a microphone means to register sound data and causes the sound data to be repeatedly stored in a sound buffer. Specifically, the sound data is stored sequentially, such that an oldest piece of stored data is overwritten with a newest piece of registered data. Hence, the buffer holds a representation of a most recently registered sound sequence at all times.

In parallel with step 320, a step 330 calculates position data reflecting an estimated geographic position for the terminal based on received satellite signals. Step 330 repeatedly updates the position data, for example at regular intervals, say once per minute. In parallel with steps 320 and 330, a step 340 also investigates whether or not a user generated command has been received, i.e. if the user has activated an alarm. If so, a step 350 follows; and otherwise the procedure loops back to steps 320, 330 and 340. Of course, the invention does not excluded that position data is calculated repeatedly also prior to receiving the surveillance command, i.e. essentially in parallel with step 310.

Step 350 causes an alarm message to be sent out to at least one predefined recipient. The alarm message is adapted to provide the at least one recipient with access to the buffered sound data and a latest estimated terminal position. After step 350, the basic procedure ends.

According to one preferred embodiment of the invention, however, a step 360 parallel to step 350 causes a call to be set up to one party (e.g. one of the predefined recipient(s)). Thus, said party is able to receive live sounds being recorded by the terminal's microphone means. If desired/appropriate, the party may also talk to the user of the terminal. Furthermore, it is preferable if a database exists, which contains personal data concerning the user of the terminal, and that the called party gains access to at least part of the personal data in connection with receiving the alarm message.

All of the steps, as well as any sub-sequence of steps, described with reference to FIG. 3, above may be controlled by means of a programmed computer apparatus. Moreover, although the embodiments of the invention described above with reference to the drawings comprise computer apparatus and processes performed in computer apparatus, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the procedure according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc), an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant procedures.

The term “comprises/comprising” when used in this specification is taken to specify the presence of stated features, integers, steps or components. However, the term does not preclude the presence or addition of one or more additional features, integers, steps or components or groups thereof.

The reference to any prior art in this specification is not, and should not be taken as, an acknowledgement or any suggestion that the referenced prior art forms part of the common general knowledge in Australia.

The invention is not restricted to the described embodiments in the figures, but may be varied freely within the scope of the claims.

1. A mobile communications terminal configured to handle bidirectional voice calls in a wireless communication network, the terminal comprising:
a microphone means configured to register sound data to be transmitted over the network,
a loudspeaker means configured to generate acoustic signals based on incoming sound data received in the terminal,
a positioning means configured to, based on received satellite signals, calculate position data reflecting an estimated geographic position of the terminal,
a sound buffer, and
a processing means configured to:
receive a user-generated command, and in response thereto,
originate an alarm message adapted to provide at least one predefined recipient with access to position data generated by the terminal,
receive a surveillance command, and in response thereto
control the microphone means to register sound data, and further
cause repeated storage of the sound data in the sound buffer, the sound data being stored sequentially such that an oldest piece of stored data is overwritten with a newest piece of registered data, and the buffer holding a representation of a most recently registered sound sequence, and
forward, in further response to the user-generated command, supplementary information to a server resource connected to the wireless communication network, the supplementary information comprising the position data and the stored sound data, the alarm message being further adapted to provide the at least one recipient with access to the stored sound data, the server resource being configured to provide each of the at least one recipient with access to the supplementary information,
the terminal is adapted to receive an acknowledge message from the server resource, the acknowledge message being generated in response to the supplementary information, and the processing means is configured to produce a confirmation indication in response to the acknowledge message, the terminal comprises a vibrator means (180), and the confirmation indication involves activating the vibrator means

2. The terminal according to claim 1, wherein the terminal is configured to receive the surveillance command in the form of a user-generated input to the terminal.

3. The terminal according to claim 1, wherein the positioning means is configured to associate a time stamp with each calculated position date, the time stamp reflecting a point in time when the terminal was estimated to be located at a given geographic position, and the processing means is configured to produce the alarm message such that the at least one recipient thereof is provided with access to a latest calculated position date and the time stamp associated thereto.

4. The terminal according to claim 1, wherein the alarm message is represented by at least one of a short messages service message and an electronic mail message.

5. The terminal according to claim 4, wherein the alarm message comprises a uniform resource locator to a world wide web resource and a passphrase adapted to provide access to said world wide web resource.

6. The terminal according to claim 1, wherein the processing means is configured to automatically set up a call to a predefined party in response to the user-generated command.

7. A terminal according to claim 6, wherein the processing means, after having set up the call, is configured to automatically effect at least one of:
adjustment of the microphone means to a sensitivity above a first threshold value, and
adjustment of the loudspeaker means to a volume level above a second threshold value.

8. The terminal according to claim 6, wherein the predefined party is identical to one of the at least one recipient of the alarm message.

9. The terminal according to claim 6, wherein terminal comprises:
an image recording means, and
a storage means configured to store image data generated by the image recording means, and
the processing means is configured to, in response the user-generated command, forward a subset of the image data stored in the storage means to the server resource (200).

10. The terminal according to claim 9, wherein the subset comprises at least one of a number of static images and a number of video sequences.

11. A method of operating a mobile communications terminal, the terminal being configured to handle bi-directional voice calls in a wireless communication network, the terminal comprising: a microphone means configured to register sound data to be transmitted over the network; a loudspeaker means configured to generate acoustic signals based on incoming sound data received in the terminal; and a positioning means configured to, based on received satellite signals, calculate position data reflecting an estimated geographic position of the terminal, the method comprising:
receiving a user-generated command, and in response thereto,
originating an alarm message adapted to provide at least one predefined recipient with access to position data generated by the terminal,
receiving a surveillance command, and in response thereto
controlling the microphone means to register sound data, and
storing repeatedly the sound data in a sound buffer in the terminal, the sound data being stored sequentially such that an oldest piece of stored data is overwritten with a newest piece of registered data, and the buffer holding a representation of a most recently registered sound sequence, and
forwarding, in response to the user-generated command, supplementary information including the position data and the stored sound data to a server resource connected to the wireless communication network, the alarm message being further adapted to provide the at least one recipient with access to the stored sound data,
providing, via the server resource, each of the at least one recipient with access to the supplementary information,
generating an acknowledge message in the server resource in response to the supplementary information,
sending the acknowledge message to the terminal, and producing a confirmation indication in the terminal in response to the acknowledge message, the confirmation indication involving activating a vibrator means in the terminal.

12. The method according to claim 11, comprising:
associating a time stamp with each calculated position date, the time stamp reflecting a point in time when the terminal was estimated to be located at a given geographic position, and
producing the alarm message such that the at least one recipient thereof is provided with access to a latest calculated position date and the time stamp associated thereto.

13. The method according to claim 11, wherein the alarm message is represented by at least one of a short messages service message and an electronic mail message.

14. The method according to claim 13, wherein the alarm message comprises a uniform resource locator to a world wide web resource and a passphrase adapted to provide access to said world wide web resource.

15. The method according to claim 14, comprising setting up a call, automatically, to a predefined party in response to the user-generated command.

16. The method according to claim 15, wherein after having set up the call, method comprising at least one of:
adjusting, automatically, the microphone means to a sensitivity above a first threshold value, and
adjusting, automatically, the loudspeaker means to a volume level above a second threshold value.

17. The method according to claim 16, wherein the predefined party is identical to one of the at least one recipient of the alarm message.

18. The method according to claim 17, comprising forwarding, in response the user-generated command, a subset of image data stored in a storage means in the terminal to the server resource, the image data having been generated by an image recording means in the terminal.

19. The method according to claim 18, wherein the subset comprises at least one of a number of static images and a number of video sequences.

20. A computer program product loadable into the memory of a computer, comprising software for receiving a user-generated command (A), and in response thereto; originating an alarm message adapted to provide at least one predefined recipient with access to position data generated by the terminal; receiving a surveillance command, and in response thereto, controlling the microphone means to register sound data storing repeatedly the sound data in a sound buffer in the terminal, the sound data being stored sequentially such that an oldest piece of stored data is overwritten with a newest piece of registered data, and the buffer holding a representation of a most recently registered sound sequence; forwarding, in response to the user-generated command, supplementary information including the position data and the stored sound data to a server resource connected to the wireless communication network, the alarm message being further adapted to provide the at least one recipient with access to the stored sound data; providing, via the server resource, each of the at least one recipient with access to the supplementary information; generating an acknowledge message in the server resource in response to the supplementary information; and sending the acknowledge message to the terminal, and producing a confirmation indication in the terminal in response to the acknowledge message, the confirmation indication involving activating a vibrator means in the terminal.

21. A computer readable medium, having a program recorded thereon, where the program is configured to make a computer receive a user-generated command (A), and in response thereto; originating an alarm message adapted to provide at least one predefined recipient with access to position data generated by the terminal; receive a surveillance command, and in response thereto, control the microphone means to register sound data; store repeatedly the sound data in a sound buffer in the terminal, the sound data being stored sequentially such that an oldest piece of stored data is overwritten with a newest piece of registered data, and the buffer holding a representation of a most recently registered sound sequence; forward, in response to the user-generated command, supplementary information including the position data and the stored sound data to a server resource connected to the wireless communication network, the alarm message being further adapted to provide the at least one recipient with access to the stored sound data; provide, via the server resource, each of the at least one recipient with access to the supplementary information; generate an acknowledge message in the server resource in response to the supplementary information; and send the acknowledge message to the terminal, and produce a confirmation indication in the terminal in response to the acknowledge message, the confirmation indication involving activating a vibrator means in the terminal.
